(19) United States
(12) Patent Application Publication
(10) Pub. No.: US 2024/0194032 A1
(43) Pub. Date: Jun. 13, 2024

(54) SERVICE PROVIDING SERVER FOR PROVIDING A GAME SERVICE THAT SUPPORTS PARTICIPATION IN TOURNAMENTS FOR GAMES USING TICKETS AND ENABLES BETTING ON MEMBERS PARTICIPATING IN TOURNAMENTS AND THE OPERATING METHOD THEREOF

(71) Applicant: Supertree Co., Ltd., Seoul (KR)

(72) Inventor: Sung Wone CHOI, Seoul (KR)

(73) Assignee: Supertree Co., Ltd., Seoul (KR)

(21) Appl. No.: 18/523,910

(22) Filed: Nov. 30, 2023

(30) Foreign Application Priority Data
Dec. 7, 2022 (KR) 10-2022-0169394

(51) Int. Cl. G07F 17/32

(52) U.S. Cl. CPC G07F 17/3288; G07F 17/3241; G07F 17/3244; G07F 17/3276

(57) ABSTRACT

Disclosed are a service providing server for providing a game service that supports participation in tournaments for games using tickets and enables betting on members participating in the tournaments and the operating method thereof, which allow members to enjoy the games together with other members in an online environment while competing with each other in a tournament scheme, and allow betting in the tournaments for the games to support even members who do not participate in the tournament to enjoy the game service together.

### CROSS-REFERENCE TO RELATED APPLICATIONS

This application claims priority to and the benefit of Korean Patent Application No. 10-2022-0169394 filed in the Korean Intellectual Property Office on Dec. 7, 2022, the entire contents of which are incorporated herein by reference.

### TECHNICAL FIELD

The present disclosure relates to a service providing server for providing a game service that supports participation in tournaments for games using tickets and enables betting on members participating in the tournaments and the operating method thereof.

### BACKGROUND ART

Recently, as various electronic terminals including desktop PCs, smart phones, tablet PCs, console game machines, etc., have been released, the number of persons who play games through the electronic terminals has increased.

In particular, the recent electronic terminals provide an environment which enables playing games with others online, in that the electronic terminals enable online connections, and as such an environment is widely distributed, an interest in introduction of a new business model using an online based game is also increasing.

For example, by holding a tournament competition using a number of games so that people participate in the tournament of the game they want, the introduction of a business model that pays a certain reward to the winner who wins a specific tournament competition can be considered.

However, in order to provide a tournament platform service using these games, user management technology needs to be introduced, which does not allow anybody to participate in the tournament, but allows only the users who qualify for participating in a predetermined tournament to participate in the tournament to improve the quality of the service.

In this regard, the introduction of service technology can be considered, which allows only predetermined certified members to participate in the tournament, and at the same time, issues a predetermined ticket for participating in the tournament, and allows only the people who purchase this ticket to participate in the tournament of a specific game.

In order to entice people's interest in the service, a technology needs to be introduced, in which a betting session to bet tournament participants is opened to allow even persons who do not participate in the tournament to participate in the betting to enjoy the service together, and if the persons succeed in the betting, a predetermined reward is paid to cause the interest in the tournament.

In this regard, the introduction of service technology can be considered, which allows only predetermined certified members to participate in the tournament, and at the same time, issues a predetermined ticket for participating in the tournament, and allows only the people who purchase this ticket to participate in the tournament of a specific game and allows betting on the member who participates in the tournament.

### SUMMARY OF THE INVENTION

The present disclosure has been made in an effort to provide a service providing server for providing a game service that supports participation in tournaments for games using tickets and enables betting on members participating in the tournaments and the operating method thereof to allow members to enjoy the games together with other members in an online environment while competing with each other in a tournament scheme, and allows betting in the tournaments for the games to support even members who do not participate in the tournament to enjoy the game service together.

An exemplary embodiment of the present disclosure provides a service providing server for providing a game service that supports participation in tournaments for games using tickets and enables betting on members participating in tournaments, which includes: a game information storage unit storing information on the number of required tickets for participating in tournaments of a plurality of predetermined respective games; a ticket information storage unit storing information on the quantity of holding tickets held by each of a plurality of members which subscribes to the game service; a wallet address storage unit storing information on a wallet address for accumulating cryptocurrency held by each of the plurality of members; a confirmation unit conducting, when an access request command to a tournament session, wherein the tournament session means a session opened for allowing members accessing to the tournament session through the electronic terminal to play the first game online jointly, opened for a first game which is any one of the plurality of games is received from a first electronic terminal of a first member which is any one of the plurality of members, certification for the first member, and then confirming a first required number which is the number of required tickets for participating in the tournament of the first game by referring to the game information storage unit, and confirming the quantity of holding tickets held by the first member by referring to the ticket information storage unit; a reduction processing unit allowing, when it is confirmed that the quantity of holding tickets held by the first member is equal to or more than the first required number, the first electronic terminal to access the tournament session, and then reducing the quantity of holding tickets for the first member stored in the ticket information storage unit by the first required number; an opening unit opening, after the access of the first electronic terminal to the tournament session is permitted, when there is a situation in which the first member is matched with a second member who accesses the tournament session to perform a battle for the first game, a betting session for betting on a member who is predicted to win the game between the first member and the second member; and a processing unit confirming, after a betting request command for any one member of the first member and the second member is received from electronic terminals of a plurality of betting participation members who accesses the betting session among the plurality of members, a wallet address of each of first betting members who bet on the first member among the plurality of betting participation members by referring to the wallet address storage unit, and then transfers cryptocurrency of a predetermined dividend payment amount to the wallet address of each of the first betting members to complete reward processing for the first betting members when it is determined that the first member wins the first game according to a result of performing the battle for the first game, and confirms a wallet address of each of second betting members who bet on the second member among the plurality of betting participation members by referring to the wallet address storage unit, and then transfers cryptocurrency of the dividend payment amount to the wallet address of each of the second betting members to complete the reward processing for the second betting members when it is determined that the second member wins the first game.

Another exemplary embodiment of the present disclosure provides an operating method of a service providing server for providing a game service that supports participation in tournaments for games using tickets and enables betting on members participating in tournaments, which includes: maintaining a game information storage unit storing information on the number of required tickets for participating in tournaments of a plurality of predetermined respective games; maintaining a ticket information storage unit storing information on the quantity of holding tickets held by each of a plurality of members which subscribes in the game service; maintaining a wallet address storage unit storing information on a wallet address for accumulating cryptocurrency held by each of the plurality of members; conducting, when an access request command to a tournament session, wherein the tournament session means a session opened for allowing members accessing to the tournament session through the electronic terminal to play the first game online jointly, opened for a first game which is any one of the plurality of games is received from a first electronic terminal of a first member which is any one of the plurality of members, certification for the first member, and then confirming a first required number which is the number of required tickets for participating in the tournament of the first game by referring to the game information storage unit, and confirming the quantity of holding tickets held by the first member by referring to the ticket information storage unit; allowing, when it is confirmed that the quantity of holding tickets held by the first member is equal to or more than the first required number, the first electronic terminal to access the tournament session, and then reducing the quantity of holding tickets for the first member stored in the ticket information storage unit by the first required number; opening, after the access of the first electronic terminal to the tournament session is permitted, when there is a situation in which the first member is matched with a second member who accesses the tournament session to perform a battle for the first game, a betting session for betting on a member who is predicted to win the game between the first member and the second member; and confirming, after a betting request command for any one member of the first member and the second member is received from electronic terminals of a plurality of betting participation members who accesses the betting session among the plurality of members, a wallet address of each of first betting members who bet on the first member among the plurality of betting participation members by referring to the wallet address storage unit, and then transferring cryptocurrency of a predetermined dividend payment amount to the wallet address of each of the first betting members to complete reward processing for the first betting members when it is determined that the first member wins the first game according to a result of performing the battle for the first game, and confirming a wallet address of each of second betting members who bet on the second member among the plurality of betting participation members by referring to the wallet address storage unit, and then transferring cryptocurrency of the dividend payment amount to the wallet address of each of the second betting members to complete the reward processing for the second betting members when it is determined that the second member wins the first game.

According to an exemplary embodiment of the present disclosure, a service providing server for providing a game service that supports participation in tournaments for games using tickets and enables betting on members participating in the tournaments and the operating method thereof are provided to allow members to enjoy the games together with other members in an online environment while competing with each other in a tournament scheme, and allows betting in the tournaments for the games to support even members who do not participate in the tournament to enjoy the game service together.

### BRIEF DESCRIPTION OF THE DRAWINGS

FIG. 1 is a diagram illustrating a structure of a service providing server for providing game services that support participation in tournaments for games using tickets, and enable betting on members participating in the tournaments according to an exemplary embodiment of the present disclosure.

FIG. 2 is a diagram for describing an operation of a service providing server for providing game services that support participation in tournaments for games using tickets, and enable betting on members participating in the tournaments according to an exemplary embodiment of the present disclosure.

FIG. 3 is a flowchart illustrating an operating method of a service providing server for providing game services that support participation in tournaments for games using tickets, and enable betting on members participating in the tournaments according to an exemplary embodiment of the present disclosure.

### DETAILED DESCRIPTION

Hereinafter, exemplary embodiments of the present disclosure will be described in detail with reference to the accompanying drawings. The description does not limit the present disclosure to specific exemplary embodiments, and it should be understood that the present disclosure covers all the modifications, equivalents and replacements included within the idea and technical scope of the present disclosure. In describing each drawing, like reference numerals refer to like elements and if not contrarily defined, all terms used herein including technological or scientific terms have the same meanings as those generally understood by a person with ordinary skill in the art.

In this document, unless explicitly described to the contrary, the word “comprise” and variations such as “comprises” or “comprising”, will be understood to imply the inclusion of stated elements but not the exclusion of any other elements. Further, in various exemplary embodiments of the present disclosure, each of the components, functional blocks or means may be constituted by one or more lower components and electrical, electronic, and mechanical functions performed by respective components may be implemented as various known devices or mechanical elements including an electronic circuit, an integrated circuit, an Application Specific Integrated Circuit (ASIC), etc., and the respective components may be separately implemented or two or more components may be integrated into one and implemented.

Meanwhile, blocks of the accompanying block diagram or steps of a flowchart may be appreciated as meaning computer program instructions mounted on a processor or a memory of data processible equipment such as a universal computer, a special computer, a portable notebook computer, a network computer, etc., and performing designated functions. Since the computer program instructions may be stored in a memory provided in a computer device or a computer readable memory, functions described in blocks of a block diagram or steps of a flowchart may be produced as a manufactured object including an instruction mean performing the functions. Moreover, each block or each step may represent a part of a module, a segment, or a code that includes one or more executable instructions for executing a specified logical function(s). It should also be noted that in some replaceable embodiments, the functions mentioned in the blocks or steps may also be executed differently from a predetermined order. For example, two blocks or steps that are subsequently illustrated are substantially simultaneously carried out, or may be performed in a reverse order, and in some cases, the functions may be performed while some blocks or steps are omitted.

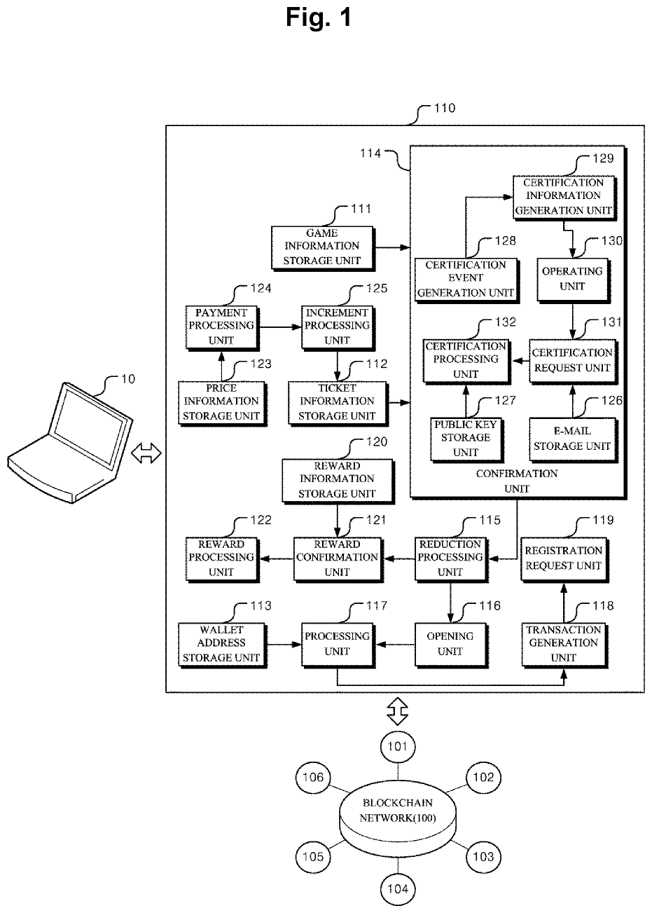

FIG. 1 is a diagram illustrating a structure of a service providing server for providing game services that support participation in tournaments for games using tickets, and enable betting on members participating in the tournaments according to an exemplary embodiment of the present disclosure.

Referring to FIG. 1, the service providing server 110 according to the present disclosure may include a game information storage unit 111, a ticket information storage unit 112, a wallet address storage unit 113, a confirmation unit 114, a reduction processing unit 115, an opening unit 116, and a processing unit 117.

The game information storage unit 111 stores information on the number of required tickets for participating in tournaments of a plurality of predetermined respective games.

For example, the game information storage unit 111 may store information shown in Table 1 below.

TABLE 1

| Plurality of games | Number of required tickets |
|---|---|
| Game 1 | 2 |
| Game 2 | 1 |
| Game 3 | 5 |
| Game 4 | 7 |
| . . . | . . . |

The ticket information storage unit 112 stores information on the quantity of holding tickets held by each of a plurality of members which subscribes to the game service.

For example, the ticket information storage unit 112 may store information shown in Table 2 below.

TABLE 2

| Plurality of members | Quantity of holding tickets |
|---|---|
| Member 1 | 10 |
| Member 2 | 30 |
| Member 3 | 0 |
| Member 4 | 5 |
| . . . | . . . |

The wallet address storage unit 113 stores information on a wallet address for accumulating cryptocurrency held by each of the plurality of members.

For example, the wallet address storage unit 113 may store information as in Table 3 below.

TABLE 3

| Plurality of members | Wallet address |
|---|---|
| Member 1 | Address 1 |
| . . . | . . . |
| Member 2 | Address 2 |
| Member 3 | Address 3 |
| Member 4 | Address 4 |
| . . . | . . . |

In such a situation, an operator of the service providing server 110 according to the present disclosure may hold a tournament competition for each of the plurality of games in order to provide the game service, and in this case, the operator may open a tournament session of each of the plurality of games online in order to allow the members to participate in the tournament competition for each of the plurality of games online through electronic terminals held by the members.

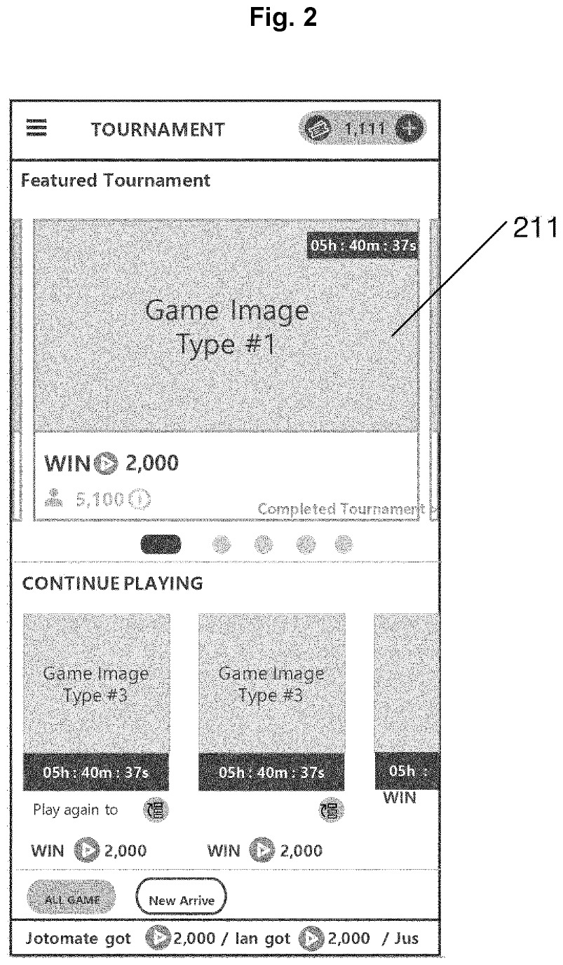

In this regard, FIG. 2 is a diagram illustrating an example of a screen in which when a specific member accesses the service providing server 110 through an electronic terminal thereof, a tournament session of each of the plurality of games is opened, which may be viewed through the electronic terminal. Here, when reference numeral 211 of FIG. 2 represents a screen in which a tournament session for a first game which is any one of the plurality of games is opened, the tournament session means a session opened so as for members who accesses the tournament session to play the first game online together through the electronic terminal. That is, multiple members access the tournament session through electronic terminals thereof to play the first game jointly with each other online.

As a result, when a first member which is any one of the plurality of members accesses the service providing server 110 through a first electronic terminal 10 thereof, the first member may view a waiting room screen having a UI shown in FIG. 2 through the first electronic terminal 10.

In this case, when the first member clicks on the tournament session for the first game represented by reference numeral 211 through the first electronic terminal 10, the first electronic terminal 10 may transmit, to the service providing server 110 of the present disclosure, an access request command to the tournament session.

In this case, when the confirmation unit 114 receives, from the first electronic terminal 10, the access request command to the tournament session opened for the first game, the confirmation unit 114 conducts certification for the first member, and then confirms a first required number which is the number of required tickets for participating in the tournament of the first game by referring to the game information storage unit 111, and confirms the quantity of holding tickets held by the first member by referring to the ticket information storage unit 112.

When it is confirmed that the quantity of holding tickets held by the first member is equal to or more than the first required number, the reduction processing unit 115 allows the first electronic terminal 10 to access the tournament session, and then reduces the quantity of holding tickets for the first member stored in the ticket information storage unit 112 by the first required number.

In this regard, when it is assumed that the information is stored in the game information storage unit 111 as in Table 1 above and the information is stored in the ticket information storage unit 112 as in Table 2 above, and the first game is referred to as ‘game 2 and the first member is referred to as ‘member 4’, since ‘5’ which is the quantity of holding tickets held by ‘member 4’ is equal to or more than ‘1’ which is the first required number to participate in the tournament for ‘game 2’, the reduction processing unit 115 may allow the first electronic terminal 10 to access the tournament session for ‘game 2’, and then reduce the quantity of holding tickets held by ‘member 4’ stored in the ticket information storage unit 112 by ‘1’, and change the quantity of holding tickets to ‘4’.

As such, after the access of the first electronic terminal 10 to the tournament session is permitted, when there is a situation in which the first member is matched with a second member who accesses the tournament session to perform a battle for the first game, the opening unit 116 opens a betting session for betting on a member who is predicted to win the game between the first member and the second member.

After a betting request command for any one member of the first member and the second member is received from electronic terminals of a plurality of betting participation members who accesses the betting session among the plurality of members, the processing unit 117 confirms a wallet address of each of first betting members who bet on the first member among the plurality of betting participation members by referring to the wallet address storage unit 113, and then transfers cryptocurrency of a predetermined dividend payment amount to the wallet address of each of the first betting members to complete reward processing for the first betting members when it is determined that the first member wins the first game according to a result of performing the battle for the first game, and confirms a wallet address of each of second betting members who bet on the second member among the plurality of betting participation members by referring to the wallet address storage unit 113, and then transfers cryptocurrency of the dividend payment amount to the wallet address of each of the second betting members to complete the reward processing for the second betting members when it is determined that the second member wins the first game.

In this regard, it is assumed that the information is stored in the wallet address storage unit 113 as in Table 3 above, the first member is ‘member 4 and the second member is ‘member 2’, the first game is ‘game 2’, and there is a situation in which the access of the first electronic terminal 10 to the tournament session for ‘game 2’ is permitted, and then ‘member 4’ is matched with ‘member 2’ who accesses the tournament session for ‘game 2’ and perform the battle for ‘game 2’, by the reduction processing unit 115.

Then, the opening unit 116 may open a betting session for betting on a member who is predicted to win the game of ‘member 4’ and ‘member 2’.

In this case, when a plurality of betting participation members who accesses the betting session among the plurality of members are ‘member 5’, ‘member 6’, ‘member 7’, ‘member 8’, and ‘member 9’, the betting request command on ‘member 4’ may be received from electronic terminals of ‘member 5’, ‘member 8’, and ‘member 9’ by the service providing server 110, and the betting request command on ‘member 2’ may be received from electronic terminals of ‘member 6’ and ‘member 7’ by the service providing server 110.

When it is determined that ‘member 4’ wins the game according to a result of performing the battle for ‘game 2’ in which ‘member 4’ is matched with ‘member 2’, the processing unit 117 may confirm wallet addresses of ‘member 5’, ‘member 8’, and ‘member 9’ who bet on ‘member 4’, respectively as ‘address 5’, ‘address 8’, and ‘address 9’ by referring to the wallet address storage unit 113.

In this case, when the cryptocurrency of the predetermined dividend payment amount is ‘1 coin’, the processing unit 117 transfers the cryptocurrency of ‘1 coin’ to ‘address 5’, ‘address 8’, and ‘address 9’ to complete the reward processing for ‘member 5’, ‘member 8’, and ‘member 9’ who succeed in betting in the battle for ‘game 2’.

According to an exemplary embodiment of the present disclosure, the service providing server 110 may further include a transaction generation unit 118 and a registration request unit 119.

When the transfer processing of the cryptocurrency of the dividend payment amount for the first game is completed by the processing unit 117, the transaction generation unit 118 generates a transaction including winning and losing result information for the first game, information on betting members who receive the dividend payment amount, and information on the dividend payment amount received by each betting member.

When the transaction is generated, the registration request unit 119 randomly selects a first node device which is any one of a plurality of node devices 101, 102, 103, 104, 105, and 106 constituting the blockchain network 100, and transmits a registration request of the transaction in the blockchain network 100 while transmitting the transaction to the first node device.

In this regard, as in the above-described example, it is assumed that the first game is ‘game 2’, and it is determined that ‘member 4’ wins the battle for ‘game 2’, and as a result, the transfer processing of the cryptocurrency of ‘1 coin’ as the dividend payment amount is completed with respect to for ‘member 5’, ‘member 8’, and ‘member 9’ who bet on ‘member 4’ by the processing unit 117.

Then, the transaction generation unit 118 may generate a transaction including winning and losing result information for ‘game 2’, information on ‘member 5’, ‘member 8’, and ‘member 9’ who receive the dividend payment amount, and information on the cryptocurrency of ‘1 coin’ received by each betting member.

Then, the registration request unit 119 may randomly select the node device 101 which is any one of the plurality of node devices 101, 102, 103, 104, 105, and 106 constituting the blockchain network 100, and transmit the registration request of the transaction in the blockchain network 100 while transmitting the transaction to the node device 101.

In this case, when the first node device receives the transaction and the registration request from the service providing server 110, the first node device generates a first block including the transaction based on a previous block connected to blockchain data stored in a memory of the first node device by a chain, and connects the first block to the blockchain data by the chain to complete storing of the first block, and then propagates the first block to the remaining node devices other than the first node device among the plurality of node devices 101, 102, 103, 104, 105, and 106 through the blockchain network 100.

For example, as in the above-described example, as the registration request unit 119 transmits the registration request of the transaction in the blockchain network 100 while transmitting the transaction to the node device 101, when the node device 101 receives the transaction and the registration request from the service providing server 110, the node device 101 may generate the first block including the transaction based on the previous block connected to the blockchain data stored in the memory of the node device 101 by the chain.

Then, the node device 101 connects the first block to the blockchain data by the chain to complete storing the first block, and then propagate the first block to the remaining node devices 102, 103, 104, 105, and 106 through the blockchain network 100. Then, the remaining node devices 102, 103, 104, 105, and 106 connect the first block to the blockchain data by the chain based on the previous block connected to the blockchain data stored in each node device by the chain to share the transaction.

According to an exemplary embodiment of the present disclosure, the service providing server 110 may further include a reward information storage unit 120, a reward confirmation unit 121, and a reward processing unit 122.

The reward information storage unit 120 stores information on the amount of payment of cryptocurrency to be paid as a reward when winning the tournament for each of the plurality of games.

For example, the reward information storage unit 120 may store information shown in Table 4 below.

TABLE 4

| | Cryptocurrency payment |
|---|---|
| Plurality of games | amount when winning |
| Game 1 | 5 coins |
| Game 2 | 2 coins |
| Game 3 | 13 coins |
| Game 4 | 20 coins |
| . . . | . . . |

When an event occurs, which indicates that the first member is a winner through the tournament session as the first members wins the tournament for the first game after the first member completes participating in the tournament for the first game as the first electronic terminal 10 accesses the tournament session, the reward confirmation unit 119 confirms a first payment amount which is the payment amount of the cryptocurrency to be paid as the reward when winning the tournament for the first game by referring to the reward information storage unit 120, and confirms the wallet address of the first member by referring to the wallet address storage unit 113.

The reward processing unit 122 transfers the cryptocurrency of the first payment amount to the wallet address of the first member to complete reward processing for the first member.

In this regard, as in the above-described example, it is assumed that the information shown in Table 3 above is stored in the wallet address storage unit 113. Further, a situation is assumed in which the first member is ‘member 4’, the first game is ‘game 2’, and as the first electronic terminal 10 accesses the tournament session opened for ‘game 2’, ‘member 4’ completes participating in the tournament for ‘game 2’.

When ‘member 4’ wins the tournament for ‘game 2’, the service providing server 110 may generate an event indicating that ‘member 4’ is the winner through the tournament session opened for ‘game 2’. As such, when the event indicating that ‘member 4’ is the winner is generated through the tournament session opened for ‘game 2’, the reward confirmation unit 121 may confirm that the payment amount of the cryptocurrency to be paid as the reward when winning the tournament for ‘game 2’ is ‘2 coins’ by referring to the reward information storage unit 120, and confirm the wallet address of ‘member 4 as’‘address 4’ by referring to the wallet address storage unit 113.

Then, the reward processing unit 122 transfers the cryptocurrency as much as ‘2 coins’ to ‘address 4’ which is the wallet address of ‘member 4’ to complete reward processing for ‘member 4’.

Through this, when the members win the tournaments for the games participated thereby, the members may receive the rewards thereof as cryptocurrency, and will be able to more actively participate in the tournaments for the games due to the reward.

According to an exemplary embodiment of the present disclosure, the service providing server 110 may further include a price information storage unit 123, a payment processing unit 124, and an increment processing unit 125.

The price information storage unit 123 stores purchase price information of the ticket for participating in the tournament.

For example, the price information storage unit 123 may store purchase price information of ‘5000 won per ticket’ as the purchase price information of the ticket.

The payment processing unit 124 requests, upon receiving the purchase request command of requesting purchasing tickets as many as a first purchase quantity from a third electronic terminal of a third member which is any one of the plurality of members, transmission of payment means information to the third electronic terminal, and upon receiving first payment means information from the third electronic terminal, calculates a price corresponding to the first purchase quantity based on the purchase price information, and then performs payment processing for the calculated price based on the first payment means information.

For example, it is assumed that the third member is ‘member 3’, and the purchase price information of the ticket is designated as ‘5000 won per ticket’.

In this case, when the service providing server 110 receives the purchase request command of requesting purchasing ‘5’ tickets from the third electronic terminal of ‘member 3’, the payment processing unit 124 may request transmission of the payment means information to the third electronic terminal, and when the service providing server 110 receives credit card information from the third electronic terminal in response thereto, the payment processing unit 124 may calculate a price corresponding to the purchase quantity of ‘5’ tickets as ‘25000 won’ based on the purchase price information, and then perform payment processing for ‘25000 won’ based on the credit card information.

When the payment processing is completed, the increment processing unit 125 increases the quantity of holding tickets for the third member stored in the ticket information storage unit 112 by the first purchase quantity.

In this regard, as in the above-described example, when the ticket information storage unit 112 stores the information shown in Table 2 above, and the payment processing for ‘25000 won’ is completed by the payment processing unit 124, the increment processing unit 125 may increase the quantity of holding tickets for ‘member 3’ stored in the ticket information storage unit 112 by ‘5, and change the quantity of holding tickets to ‘5’.

According to an exemplary embodiment of the present disclosure, upon receiving the access request command to the tournament session opened for the first game from the first electronic terminal 10 of the first member, the service providing server 110 performs the certification for the first member, and then only when it is confirmed that the first member is a certified member, the service providing server 110 may further include a configuration of conducting a process for determining whether to allow the first electronic terminal 10 to access the tournament session based on the ticket held by the first member.

To this end, the confirmation unit 114 may include an e-mail storage unit 126, a public key storage unit 127, a certification event generation unit 128, a certification information generation unit 129, an operating unit 130, a certification request unit 131, and a certification processing unit 132.

The e-mail storage unit 126 stores information on a predetermined e-mail address for each of the plurality of members.

In this regard, the e-mail storage unit 126 may store information as in Table 5 below.

TABLE 5

| Plurality of members | E-mail address |
|---|---|
| Member 1 | E-mail address 1 |
| Member 2 | E-mail address 2 |
| Member 3 | E-mail address 3 |
| Member 4 | E-mail address 4 |
| . . . | . . . |

The public key storage unit 127 stores a public key corresponding to a private key (the private key for each of the plurality of members is stored in the electronic terminal of each member) pre-issued for each of the plurality of members.

In this regard, the public key storage unit 127 may store information as in Table 6 below.

TABLE 6

| Plurality of members | Public key |
|---|---|
| Member 1 | Public key 1 |
| Member 2 | Public key 2 |
| Member 3 | Public key 3 |
| Member 4 | Public key 4 |
| . . . | . . . |

The certification event generation unit 128 generates a certification event for conducting the certification for the first member when receiving the access request command to the tournament session from the first electronic terminal 10.

The certification information generation unit 129 randomly generates, when the certification event is generated, a n (n is a natural number of 2 or more)-digit first certification number, randomly generates a certification value constituted by a natural number having a size of 9 or less, and then, performs a modulo operation having the certification value as a divisor for respective digit numbers constituting the first certification number to generate an n-digit second certification number.

For example, when it is assumed that n is ‘3’, the certification information generation unit 129 randomly generates a 3-digit first certification number as ‘642’, randomly generates the certification value as ‘5’, and then performs a modulo operation having ‘5’ which is the certification value as the divisor for “6’, ‘4’, and ‘2’ which are respective digit numbers constituting the first certification number to generate a 3-digit second certification number as ‘142’.

The operating unit 130 generates a column vector having respective digit numbers constituting the first certification number as components and a row vector having respective digit numbers constituting the second certification number as components, and operates a matrix multiplication between the column vector and the row vector to generate an operation matrix of an n×n size, and then operates Frobenius Norm of the operation matrix.

Here, Frobenius Norm means L2-Norm that represents the size of the matrix.

In this regard, as in the above-described example, when the first certification number is generated as ‘642’ and the second certification number is generated as ‘142’ through the certification information generation unit 129, the operating unit 130 generates a column vector having respective digit numbers constituting ‘642’ which is the first certification number as components as

$$‘ [ \begin{matrix}6 \\ 4 \\ 2\end{matrix} ] ’ ,$$

generates a row vector having respective digit numbers constituting ‘142’ which is the second certification number as components as ‘[1 4 2]‘, and then operates the matrix multiplication between the column vector and the row vector to generate an operation matrix having a size of 3×3 as

$$‘ [ \begin{matrix}6 & 24 & 12 \\ 4 & 16 & 8 \\ 2 & 8 & 4\end{matrix} ] ’ ,$$

and operate Frobenius Norm of the operation matrix.

The certification request unit 131 confirms a first e-mail address for the first member by referring to the e-mail storage unit 126, sends a certification e-mail including the first certification number with the first e-mail address as a receiving side, and then transmits the certification value to the first electronic terminal 10, and at the same time, requests an electronic signature based on the first certification number and the certification value.

For example, as in the above-described example, when the first certification number and the certification value are ‘642’ and ‘5’, respectively, and the first member is ‘member 4’, the certification request unit 131 may refer to the e-mail storage unit 126 shown in Table 5, confirm ‘e-mail address 4’ for ‘member 4’, and send the certification e-mail including ‘642’ which is the first certification number with ‘e-mail address 4’ as the receiving side. Then, the certification request unit 131 may transmit ‘5’ which is the certification value to the first electronic terminal 10, and at the same time, request the electronic signature based on the first certification number and the certification value.

In this case, according to an exemplary embodiment of the present disclosure, upon receiving the electronic signature request from the service providing server 110 jointly with the certification value, the first electronic terminal 10 may display a message for requesting the first member to input the first certification number included in the certification e-mail received by an account according to the first e-mail address into the first electronic terminal 10.

In this case, when the first member inputs, into the first electronic terminal 10, the first certification number included in the certification e-mail received by the account according to the first e-mail address in response to the message, the first electronic terminal 10 performs the modulo operation having the certification value as the divisor for the respective digit numbers constituting the first certification number to generate the n-digit second certification number, and then generate a column vector having respective digit numbers constituting the first certification number as components and a row vector having respective digit numbers constituting the second certification number as components, and operates the matrix multiplication between the column vector and the row vector to generate the operation matrix of the n×n size, and then sign the Frobenius Norm of the operation matrix with the first private key for the first member stored in the first electronic terminal 10 to generate a first electronic signature value, and transmit the generated first electronic signature value to the service providing server 110 of the present disclosure.

In this regard, as in the above-described example, when the first certification number and the certification value are ‘642’ and ‘5’, respectively, and the first member is ‘member 4’, the first electronic terminal 10 may display a message for requesting ‘member 4’ to input the first certification number included in the certification e-mail received by the account according to ‘e-mail address 4’ into the first electronic terminal 10 when receiving the electronic signature request from the service providing server 110 jointly with ‘5’ which is the certification value.

Then, ‘member 4’ logs into the account according to ‘e-mail address 4’ to confirm the certification e-mail, and confirms ‘642’ which is the first certification number included in the certification e-mail to input the ‘642’ into the first electronic terminal 10.

As such, when ‘member 4’ inputs ‘642’ which is the first certification number included in the certification e-mail into the first electronic terminal 10, the first electronic terminal 10 performs a modulo operation having ‘5’ which is the certification value as the divisor for “6’, ‘4’, and ‘2’ which are respective digit numbers constituting the first certification number to generate a 3-digit second certification number as ‘142’.

Then, the first electronic terminal 10 generates a column vector having respective digit numbers constituting ‘642’ which is the first certification number as components as

$$‘ [ \begin{matrix}6 \\ 4 \\ 2\end{matrix} ] ’$$

and generates a row vector having respective digit numbers constituting ‘142’ which is the second certification number as components as ‘[1 4 2]‘, and then operates the matrix multiplication between the column vector and the row vector to generate an operation matrix of a 3×3 size as

$$‘ [ \begin{matrix}6 & 24 & 12 \\ 4 & 16 & 8 \\ 2 & 8 & 4\end{matrix} ] ’ .$$

Then, the first electronic terminal 10 operates the Frobenius Norm of the operation matrix, and then performs the electronic signature for the Frobenius Norm based on ‘private key 4’ which is the private key for ‘member 4’ pre-stored in the first electronic terminal 10 to generate the first electronic signature value and transmit the first electronic signature value to the service providing server 110 of the present disclosure.

The certification processing unit 132 extracts, when receiving a first electronic signature value (the first electronic signature value is generated by performing, when the certification value is received in the first electronic terminal 10, and the first member inputs the first certification number included in the certification e-mail received by an account according to the first e-mail address into the first electronic terminal 10, by the first electronic terminal 10, the modulo operation having the certification value as the divisor for the respective digit numbers constituting the first certification number to generate the n-digit second certification number, and then generate a column vector having respective digit numbers constituting the first certification number as components and a row vector having respective digit numbers constituting the second certification number as components, and operating the matrix multiplication between the column vector and the row vector to generate the operation matrix of the n×n size, and then signing the Frobenius Norm of the operation matrix with the first private key for the first member stored in the first electronic terminal 10) from the first electronic terminal 10 in response to the electronic signature request, the first public key for the first member from the public key storage unit 127, and then comparing a value acquired by decoding the first electronic signature value based on the first public key and the Frobenius Norm of the operation matrix with each other, and when it is confirmed that both values coincide with each other, completing the certification for the first member.

In this regard, as in the above-described example, when the first member is ‘member 4’, the certification processing unit 132 may extract ‘public key 4’ which is a public key for ‘member 4’ from the public key storage unit 127 as in Table 6 above, and then decode the first electronic signature value based on ‘public key 4’, upon receiving the first electronic signature value from the first electronic terminal 10.

Thereafter, the certification processing unit 132 may compare a decoding value for the first electronic signature value and the Frobenius Norm of the operation matrix with each other, and when it is confirmed that both values coincide with each other, complete the certification for ‘member 4’.

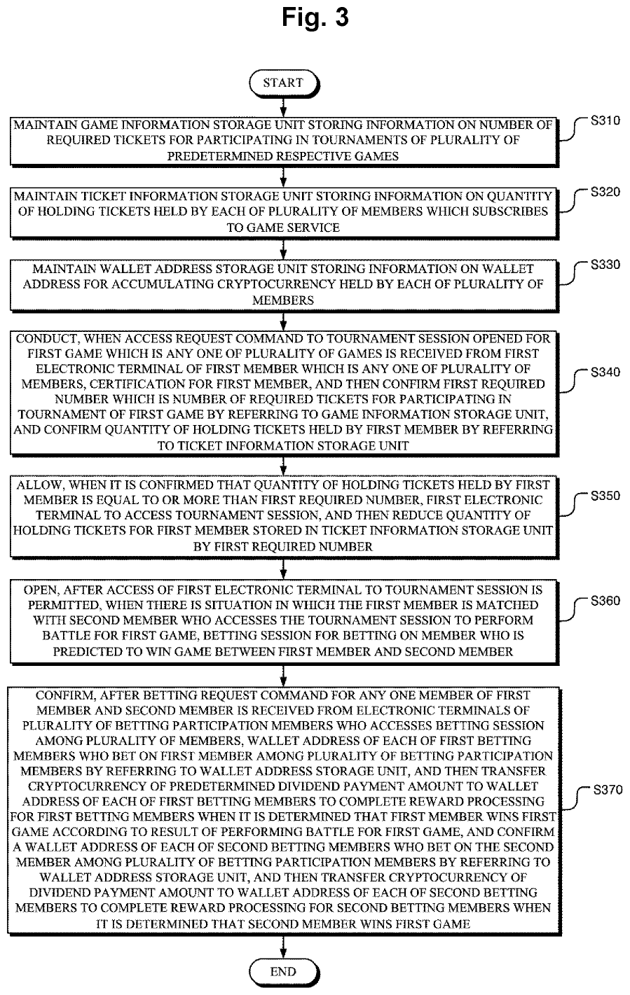

FIG. 3 is a flowchart illustrating an operating method of a service providing server for providing game services that support participation in tournaments for games using tickets, and enable betting on members participating in the tournaments according to an exemplary embodiment of the present disclosure.

In step S310, a game information storage unit is maintained, which stores information on the number of required tickets for participating in tournaments of a plurality of predetermined respective games.

In step S320, a ticket information storage unit is maintained, which stores information on the quantity of holding tickets held by each of a plurality of members which subscribes to the game service.

In step S330, a wallet address storage unit is maintained, which stores information on a wallet address for accumulating cryptocurrency held by each of the plurality of members.

In step S340, when an access request command to a tournament session (the tournament session means a session opened for allowing members accessing the tournament session through the electronic terminal to play the first game online jointly) opened for a first game which is any one of the plurality of games is received from a first electronic terminal of a first member which is any one of the plurality of members, certification for the first member is conducted, and then a first required number which is the number of required tickets for participating in the tournament of the first game is confirmed by referring to the game information storage unit, and the quantity of holding tickets held by the first member is confirmed by referring to the ticket information storage unit.

In step S350, when it is confirmed that the quantity of holding tickets held by the first member is equal to or more than the first required number, the first electronic terminal is allowed to access the tournament session, and then the quantity of holding tickets for the first member stored in the ticket information storage unit is reduced by the first required number.

In step S360, after the access of the first electronic terminal to the tournament session is permitted, when there is a situation in which the first member is matched with a second member who accesses the tournament session to perform a battle for the first game, a betting session for betting on a member who is predicted to win the game between the first member and the second member is opened.

In step S370, after a betting request command for any one member of the first member and the second member is received from electronic terminals of a plurality of betting participation members who accesses the betting session among the plurality of members, a wallet address of each of first betting members who bet on the first member among the plurality of betting participation members is confirmed by referring to the wallet address storage unit, and then transfers cryptocurrency of a predetermined dividend payment amount to the wallet address of each of the first betting members to complete reward processing for the first betting members when it is determined that the first member wins the first game according to a result of performing the battle for the first game, and confirms a wallet address of each of second betting members who bet on the second member among the plurality of betting participation members by referring to the wallet address storage unit, and then transfers cryptocurrency of the dividend payment amount to the wallet address of each of the second betting members to complete the reward processing for the second betting members when it is determined that the second member wins the first game.

In this case, according to an exemplary embodiment of the present disclosure, the operating method of the service providing server may further include, when the transfer of the cryptocurrency of the dividend payment amount for the first game is completed by step S370, generating a transaction including winning and losing result information for the first game, information on betting members receiving the dividend payment amount, and information on the dividend payment amount received by each betting member, and when the transaction is generated, randomly selecting a first node device which is any one of a plurality of node devices constituting a blockchain network, and transmitting a registration request of the transaction in the blockchain network while transmitting the transaction to the first node device.

In this case, when the first node device receives the transaction and the registration request from the service providing server, the first node device generates a first block including the transaction based on a previous block connected to blockchain data stored in a memory of the first node device by a chain, and connects the first block to the blockchain data by the chain to complete storing of the first block, and then propagates the first block to the remaining node devices other than the first node device among the plurality of node devices through the blockchain network.

According to an exemplary embodiment of the present disclosure, the operating method of the service providing server may further include a step of maintaining a reward information storage unit storing information on the amount of payment of cryptocurrency to be paid as a reward when winning the tournament for each of the plurality of games, a step of confirming, when an event occurs, which indicates that the first member is a winner through the tournament session as the first member wins the tournament for the first game after the first member completes participation in the tournament for the first game as the first electronic terminal accesses the tournament session, a first payment amount which is the payment amount of the cryptocurrency to be paid as the reward when winning the tournament for the first game by referring to the reward information storage unit, and confirming a wallet address of the first member by referring to the wallet address storage unit, and a step of completing reward processing for the first member by transferring cryptocurrency of the first payment amount to the wallet address of the first member.

According to an exemplary embodiment of the present disclosure, the operating method of the service providing server may further include a step of maintaining a price information storage unit storing purchase price information of the ticket for participating in the tournament, a step of requesting, upon receiving the purchase request command of requesting purchasing tickets as many as a first purchase quantity from a third electronic terminal of a third member which is any one of the plurality of members, transmission of payment means information to the third electronic terminal, and upon receiving first payment means information from a third electronic terminal, calculating a price corresponding to the first purchase quantity based on the purchase price information, and then performing payment processing for the calculated price based on the first payment means information, and a step of increasing, when the payment processing is completed, the quantity of holding tickets for the third member stored in the ticket information storage unit by the first purchase quantity.

According to an exemplary embodiment of the present disclosure, step S340 may include a step of maintaining an e-mail storage unit storing information on a predetermined e-mail address for each of the plurality of members, a step of maintaining a public key storage unit storing a public key corresponding to a private key (the private key for each of the plurality of members is stored in the electronic terminal of each member) pre-issued for each of the plurality of members, a step of generating a certification event for conducting the certification for the first member when receiving the access request command to the tournament session from the first electronic terminal, a step of randomly generating, the certification event is generated, an n (n is a natural number of 2 or more)-digit first certification number and randomly generating a certification value constituted by a natural number having a size of 9 or less, and then performing a module operation having the certification value as a divisor for each-digit number constituting the first certification number to generate an n-digit second certification number, a step of generating a column vector having respective digit numbers constituting the first certification number as components and a row vector having respective digit numbers constituting the second certification number as components, and operating a matrix multiplication between the column vector and the row vector to generate an operation matrix of an n×n size, and then operating Frobenius Norm of the operation matrix, a step of confirming a first e-mail address for the first member by referring to the e-mail storage unit, sending a certification e-mail including the first certification number with the first e-mail address as a receiving side, and then transmitting the certification value to the first electronic terminal, and at the same time, requesting an electronic signature based on the first certification number and the certification value, and a step of extracting, upon receiving the first electronic signature value (the first electronic signature value is generated by performing, when the certification value is received by the first electronic terminal, and the first member inputs, into the first electronic terminal, the first certification number included in the certification e-mail received by the account according to the first e-mail address, by the first electronic terminal, the modulo operation having the certification value as the divisor for each-digit number constituting the first certification number to generate the n-digit second certification number, and then generate a column vector having respective digit numbers constituting the first certification number as components and a row vector having respective digit numbers constituting the second certification number as components, and operating the matrix multiplication between the column vector and the row vector to generate the operation matrix of the n×n size, and then signing the Frobenius Norm of the operation matrix with the first private key for the first member stored in the first electronic terminal) in response to the electronic signature request from the first electronic terminal, a first public key for the first member from the public key storage unit, and then comparing a value acquired by decoding the first electronic signature value based on the first public key and the Frobenius Norm of the operation matrix with each other, and when it is confirmed that both values coincide with each other, completing the certification for the first member.

Hereinabove, referring to FIG. 3, the operating method of the service providing server according to an exemplary embodiment of the present disclosure is described. Here, since the operating method of the service providing server according to an exemplary embodiment of the present disclosure may correspond to the configuration of the operation of the service providing server 110 described by using FIG. 1, a more detailed description thereof will be omitted.

The operating method of the service providing server according to an exemplary embodiment of the present disclosure may be implemented by a computer program stored in a storage medium for executing the computer program through combination with a computer.

The operating method of the service providing server according to an exemplary embodiment of the present disclosure may be implemented in a program command type which may be performed through various computer means and recorded in a computer readable medium. The computer readable medium may include a program command, a data file, a data structure, etc., singly or combinationally. The program command recorded in the medium may be specially designed and configured for the present disclosure, or may be publicly known to and used by those skilled in the computer software field. An example of the computer readable recording medium includes magnetic media, such as a hard disk, a floppy disk, and a magnetic tape, optical media such as a CD-ROM and a DVD, magneto-optical media such as a floptical disk, and hardware devices such as a ROM, a RAM, and a flash memory, which are specially configured to store and execute the program command. An example of the program command includes a high-level language code executable by a computer by using an interpreter and the like, as well as a machine language code created by a compiler.

As described above, the present disclosure has been described by specified matters such as detailed components, and the like and limited exemplary embodiments and drawings, but the description is just provided to assist more overall understanding of the present disclosure and the present disclosure is not limited to the exemplary embodiment and various modifications and changes can be made by those skilled in the art from such a disclosure.

Accordingly, the spirit of the present disclosure should not be defined only by the described exemplary embodiments, and it should be appreciated that claims to be described below and all things which are equivalent to the claims or equivalently modified to the claims are included in the scope of the spirit of the present disclosure.

What is claimed is:

1. A service providing server for providing a game service that supports participation in tournaments for games using tickets and enables betting on members participating in tournaments, comprising:
a game information storage unit storing information on the number of required tickets for participating in tournaments of a plurality of predetermined respective games;
a ticket information storage unit storing information on the quantity of holding tickets held by each of a plurality of members which subscribes to the game service;
a wallet address storage unit storing information on a wallet address for accumulating cryptocurrency held by each of the plurality of members;
a confirmation unit conducting, when an access request command to a tournament session, wherein the tournament session means a session opened for allowing members accessing to the tournament session through the electronic terminal to play the first game online jointly, opened for a first game which is any one of the plurality of games is received from a first electronic terminal of a first member which is any one of the plurality of members, certification for the first member, and then confirming a first required number which is the number of required tickets for participating in the tournament of the first game by referring to the game information storage unit, and confirming the quantity of holding tickets held by the first member by referring to the ticket information storage unit;
a reduction processing unit allowing, when it is confirmed that the quantity of holding tickets held by the first member is equal to or more than the first required number, the first electronic terminal to access the tournament session, and then reducing the quantity of holding tickets for the first member stored in the ticket information storage unit by the first required number;
an opening unit opening, after the access of the first electronic terminal to the tournament session is permitted, when there is a situation in which the first member is matched with a second member who accesses the tournament session to perform a battle for the first game, a betting session for betting on a member who is predicted to win the game between the first member and the second member; and
a processing unit confirming, after a betting request command for any one member of the first member and the second member is received from electronic terminals of a plurality of betting participation members who accesses the betting session among the plurality of members, a wallet address of each of first betting members who bet on the first member among the plurality of betting participation members by referring to the wallet address storage unit, and then transfers cryptocurrency of a predetermined dividend payment amount to the wallet address of each of the first betting members to complete reward processing for the first betting members when it is determined that the first member wins the first game according to a result of performing the battle for the first game, and confirms a wallet address of each of second betting members who bet on the second member among the plurality of betting participation members by referring to the wallet address storage unit, and then transfers cryptocurrency of the dividend payment amount to the wallet address of each of the second betting members to complete the reward processing for the second betting members when it is determined that the second member wins the first game.

2. The service providing server of claim 1, further comprising:
a transaction generation unit generating, when the transfer processing of the cryptocurrency of the dividend payment amount for the first game is completed by the processing unit, a transaction including winning and losing result information for the first game, information on betting members who receive the dividend payment amount, and information on the dividend payment amount received by each betting member; and a registration request unit randomly selecting, when the transaction is generated, a first node device which is any one of a plurality of node devices constituting the blockchain network, and transmitting a registration request of the transaction in the blockchain network while transmitting the transaction to the first node device,
wherein when the first node device receives the transaction and the registration request from the service providing server, the first node device generates a first block including the transaction based on a previous block connected to blockchain data stored in a memory of the first node device by a chain, and connects the first block to the blockchain data by the chain to complete storing the first block, and then propagates the first block to the remaining node devices other than the first node device among the plurality of node devices through the blockchain network.

3. The service providing server of claim 1, further comprising:
a reward information storage unit storing information on the amount of payment of cryptocurrency to be paid as a reward when winning the tournament for each of the plurality of games;
a reward confirmation unit confirming, when an event occurs, which indicates that the first member is a winner through the tournament session as the first member wins the tournament for the first game after the first member completes participation in the tournament for the first game as the first electronic terminal accesses the tournament session, a first payment amount which is the payment amount of the cryptocurrency to be paid as the reward when winning the tournament for the first game by referring to the reward information storage unit, and confirming the wallet address of the first member by referring to the wallet address storage unit; and
a reward processing unit transferring the cryptocurrency of the first payment amount to the wallet address of the first member to complete reward processing for the first member.

4. The service providing server of claim 1, further comprising:
a price information storage unit storing purchase price information of the ticket for participating in the tournament;
a payment processing unit requesting, upon receiving the purchase request command of requesting purchasing tickets as many as a first purchase quantity from a third electronic terminal of a third member which is any one of the plurality of members, transmission of payment means information to the third electronic terminal, and upon receiving first payment means information from the third electronic terminal, calculating a price corresponding to the first purchase quantity based on the purchase price information, and then performing payment processing for the calculated price based on the first payment means information; and
an increment processing unit increasing, when the payment processing is completed, the quantity of holding tickets for the third member stored in the ticket information storage unit by the first purchase quantity.

5. The service providing server of claim 1, wherein the confirmation unit includes
an e-mail storage unit storing information on a predetermined e-mail address for each of the plurality of members,
a public key storage unit storing a public key corresponding to a private key, wherein the private key for each of the plurality of members is stored in the electronic terminal of each member, pre-issued for each of the plurality of members,
a certification event generation unit generating a certification event for conducting the certification for the first member when receiving the access request command to the tournament session from the first electronic terminal,
a certification information generation unit randomly generating, when the certification event is generated, a n, wherein n is a natural number of 2 or more, digit first certification number, randomly generating a certification value constituted by a natural number having a size of 9 or less, and then, performing a modulo operation having the certification value as a divisor for respective digit numbers constituting the first certification number to generate an n-digit second certification number,
an operating unit generating a column vector having respective digit numbers constituting the first certification number as components and a row vector having respective digit numbers constituting the second certification number as components, and operating a matrix multiplication between the column vector and the row vector to generate an operation matrix of an n×n size, and then operating Frobenius Norm of the operation matrix,
a certification request unit confirming a first e-mail address for the first member by referring to the e-mail storage unit, sending a certification e-mail including the first certification number with the first e-mail address as a receiving side, and then transmitting the certification value to the first electronic terminal, and at the same time, requesting an electronic signature based on the first certification number and the certification value, and
a certification processing unit extracting, when receiving a first electronic signature value, wherein the first electronic signature value is generated by performing, when the certification value is received in the first electronic terminal, and the first member inputs the first certification number included in the certification e-mail received by an account according to the first e-mail address into the first electronic terminal, by the first electronic terminal, the modulo operation having the certification value as the divisor for the respective digit numbers constituting the first certification number to generate the n-digit second certification number, and then generate a column vector having respective digit numbers constituting the first certification number as components and a row vector having respective digit numbers constituting the second certification number as components, and operating the matrix multiplication between the column vector and the row vector to generate the operation matrix of the n×n size, and then signing the Frobenius Norm of the operation matrix with the first private key for the first member stored in the first electronic terminal, from the first electronic terminal in response to the electronic signature request, the first public key for the first member from the public key storage unit, and then comparing a value acquired by decoding the first electronic signature value based on the first public key and the Frobenius Norm of the operation matrix with each other, and when it is confirmed that both values coincide with each other, completing the certification for the first member.

6. An operating method of a service providing server for providing a game service that supports participation in tournaments for games using tickets and enables betting on members participating in tournaments, comprising:
maintaining a game information storage unit storing information on the number of required tickets for participating in tournaments of a plurality of predetermined respective games;
maintaining a ticket information storage unit storing information on the quantity of holding tickets held by each of a plurality of members which subscribes in the game service;
maintaining a wallet address storage unit storing information on a wallet address for accumulating cryptocurrency held by each of the plurality of members;
conducting, when an access request command to a tournament session, wherein
the tournament session means a session opened for allowing members accessing to the tournament session through the electronic terminal to play the first game online jointly, opened for a first game which is any one of the plurality of games is received from a first electronic terminal of a first member which is any one of the plurality of members, certification for the first member, and then confirming a first required number which is the number of required tickets for participating in the tournament of the first game by referring to the game information storage unit, and confirming the quantity of holding tickets held by the first member by referring to the ticket information storage unit;
allowing, when it is confirmed that the quantity of holding tickets held by the first member is equal to or more than the first required number, the first electronic terminal to access the tournament session, and then reducing the quantity of holding tickets for the first member stored in the ticket information storage unit by the first required number;
opening, after the access of the first electronic terminal to the tournament session is permitted, when there is a situation in which the first member is matched with a second member who accesses the tournament session to perform a battle for the first game, a betting session for betting on a member who is predicted to win the game between the first member and the second member; and
confirming, after a betting request command for any one member of the first member and the second member is received from electronic terminals of a plurality of betting participation members who accesses the betting session among the plurality of members, a wallet address of each of first betting members who bet on the first member among the plurality of betting participation members by referring to the wallet address storage unit, and then transferring cryptocurrency of a predetermined dividend payment amount to the wallet address of each of the first betting members to complete reward processing for the first betting members when it is determined that the first member wins the first game according to a result of performing the battle for the first game, and confirming a wallet address of each of second betting members who bet on the second member among the plurality of betting participation members by referring to the wallet address storage unit, and then transferring cryptocurrency of the dividend payment amount to the wallet address of each of the second betting members to complete the reward processing for the second betting members when it is determined that the second member wins the first game.

7. The operating method of claim 6, further comprising:
generating, when the transfer processing of the cryptocurrency of the dividend payment amount for the first game is completed by the completing, a transaction including winning and losing result information for the first game, information on betting members who receive the dividend payment amount, and information on the dividend payment amount received by each betting member; and
randomly selecting, when the transaction is generated, a first node device which is any one of a plurality of node devices constituting the blockchain network, and transmitting a registration request of the transaction in the blockchain network while transmitting the transaction to the first node device,
wherein when the first node device receives the transaction and the registration request from the service providing server, the first node device generates a first block including the transaction based on a previous block connected to blockchain data stored in a memory of the first node device by a chain, and connects the first block to the blockchain data by the chain to complete storing the first block, and then propagates the first block to the remaining node devices other than the first node device among the plurality of node devices through the blockchain network.

8. The operating method of claim 6, further comprising:
maintaining a reward information storage unit storing information on the amount of payment of cryptocurrency to be paid as a reward when winning the tournament for each of the plurality of games;
confirming, when an event occurs, which indicates that the first member is a winner through the tournament session as the first member wins the tournament for the first game after the first member completes participating in the tournament for the first game as the first electronic terminal accesses the tournament session, a first payment amount which is the payment amount of the cryptocurrency to be paid as the reward when winning the tournament for the first game by referring to the reward information storage unit, and confirming the wallet address of the first member by referring to the wallet address storage unit; and
transferring the cryptocurrency of the first payment amount to the wallet address of the first member to complete reward processing for the first member.

9. The operating method of claim 6, further comprising:
maintaining a price information storage unit storing purchase price information of the ticket for participating in the tournament;
requesting, upon receiving the purchase request command of requesting purchasing tickets as many as a first purchase quantity from a third electronic terminal of a third member which is any one of the plurality of members, transmission of payment means information to the third electronic terminal, and upon receiving first payment means information from the third electronic terminal, calculating a price corresponding to the first purchase quantity based on the purchase price information, and then performing payment processing for the calculated price based on the first payment means information; and
increasing, when the payment processing is completed, the quantity of holding tickets for the third member stored in the ticket information storage unit by the first purchase quantity.

10. The operating method of claim 6, wherein the conducting includes
maintaining an e-mail storage unit storing information on a predetermined e-mail address for each of the plurality of members,
maintaining a public key storage unit storing a public key corresponding to a private key, wherein the private key for each of the plurality of members is stored in the electronic terminal of each member, pre-issued for each of the plurality of members,
generating a certification event for conducting the certification for the first member when receiving the access request command to the tournament session from the first electronic terminal,
randomly generating, when the certification event is generated, a n, wherein n is a natural number of 2 or more, digit first certification number, randomly generating a certification value constituted by a natural number having a size of 9 or less, and then, performing a modulo operation having the certification value as a divisor for respective digit numbers constituting the first certification number to generate an n-digit second certification number,
generating a column vector having respective digit numbers constituting the first certification number as components and a row vector having respective digit numbers constituting the second certification number as components, and operating a matrix multiplication between the column vector and the row vector to generate an operation matrix of an n×n size, and then operating Frobenius Norm of the operation matrix,
confirming a first e-mail address for the first member by referring to the e-mail storage unit, sending a certification e-mail including the first certification number with the first e-mail address as a receiving side, and then transmitting the certification value to the first electronic terminal, and at the same time, requesting an electronic signature based on the first certification number and the certification value, and
performing, when receiving a first electronic signature value, wherein the first electronic signature value is generated by performing, when the certification value is received in the first electronic terminal, and the first member inputs the first certification number included in the certification e-mail received by an account according to the first e-mail address into the first electronic terminal, by the first electronic terminal, the modulo operation having the certification value as the divisor for the respective digit numbers constituting the first certification number to generate the n-digit second certification number, and then generate a column vector having respective digit numbers constituting the first certification number as components and a row vector having respective digit numbers constituting the second certification number as components, and operating the matrix multiplication between the column vector and the row vector to generate the operation matrix of the n×n size, and then signing the Frobenius Norm of the operation matrix with the first private key for the first member stored in the first electronic terminal, from the first electronic terminal in response to the electronic signature request, the first public key for the first member from the public key storage unit, and then comparing a value acquired by decoding the first electronic signature value based on the first public key and the Frobenius Norm of the operation matrix with each other, and when it is confirmed that both values coincide with each other, completing the certification for the first member.

11. A non-transitory computer readable recording medium having a program recorded therein for allowing a computer to execute an operating method of a service providing server for providing a game service that supports participation in tournaments for games using tickets and enables betting on members participating in tournaments, comprising:
maintaining a game information storage unit storing information on the number of required tickets for participating in tournaments of a plurality of predetermined respective games;
maintaining a ticket information storage unit storing information on the quantity of holding tickets held by each of a plurality of members which subscribes in the game service;
maintaining a wallet address storage unit storing information on a wallet address for accumulating cryptocurrency held by each of the plurality of members;
conducting, when an access request command to a tournament session, wherein the tournament session means a session opened for allowing members accessing to the tournament session through the electronic terminal to play the first game online jointly, opened for a first game which is any one of the plurality of games is received from a first electronic terminal of a first member which is any one of the plurality of members, certification for the first member, and then confirming a first required number which is the number of required tickets for participating in the tournament of the first game by referring to the game information storage unit, and confirming the quantity of holding tickets held by the first member by referring to the ticket information storage unit;
allowing, when it is confirmed that the quantity of holding tickets held by the first member is equal to or more than the first required number, the first electronic terminal to access the tournament session, and then reducing the quantity of holding tickets for the first member stored in the ticket information storage unit by the first required number;
opening, after the access of the first electronic terminal to the tournament session is permitted, when there is a situation in which the first member is matched with a second member who accesses the tournament session to perform a battle for the first game, a betting session for betting on a member who is predicted to win the game between the first member and the second member; and
confirming, after a betting request command for any one member of the first member and the second member is received from electronic terminals of a plurality of betting participation members who accesses the betting session among the plurality of members, a wallet address of each of first betting members who bet on the first member among the plurality of betting participation members by referring to the wallet address storage unit, and then transferring cryptocurrency of a predetermined dividend payment amount to the wallet address of each of the first betting members to complete reward processing for the first betting members when it is determined that the first member wins the first game according to a result of performing the battle for the first game, and confirming a wallet address of each of second betting members who bet on the second member among the plurality of betting participation members by referring to the wallet address storage unit, and then transferring cryptocurrency of the dividend payment amount to the wallet address of each of the second betting members to complete the reward processing for the second betting members when it is determined that the second member wins the first game.
